(19) United States
(12) Patent Application Publication
(10) Pub. No.: US 2022/0292559 A1
(43) Pub. Date: Sep. 15, 2022

(54) ORDER-RECEIVING-SIDE NEGOTIATION DEVICE, ORDER-RECEIVING-SIDE NEGOTIATION METHOD, AND ORDER-RECEIVING-SIDE NEGOTIATION PROGRAM

(71) Applicant: NEC corporation, Minato-ku, Tokyo (JP)

(72) Inventors: Tomohito ANDO, Tokyo (JP); Shinji NAKADAI, Tokyo (JP); Satoshi MORINAGA, Tokyo (JP)

(73) Assignee: NEC corporation, Minato-ku, Tokyo (JP)

(21) Appl. No.: 17/633,394

(22) PCT Filed: Aug. 22, 2019
(86) PCT No.: PCT/JP2019/032748

§ 371 Date: Feb. 7, 2022

(51) Int. Cl. G06Q 30/06

(52) U.S. Cl. CPC G06Q 30/0611

(57) ABSTRACT

An order-receiving-side negotiation device 20 for negotiating with an order-placing source who presents, to an order-receiving side that provides any product or service, an order proposal that represents a request for provision of the any product or service under predetermined negotiation conditions, includes: a planning unit 21 which prepares one or more negotiation candidates based on the predetermined negotiation conditions presented in the order proposal; an order-receiving-side's utility computation unit 22 which computes utility values for the order-receiving side with respect to the negotiation candidates; an order-placing source's utility estimation unit 23 which estimates utility values for the order-placing source with respect to the negotiation candidates; and a negotiation candidate determination unit 24 which determines a negotiation candidate with respect to the order proposal from among the plurality of negotiation candidates based on both the utility values for the order-receiving side and the utility values for the order-placing source.

### TECHNICAL FIELD

The present invention relates to an order-receiving-side negotiation device, an order-receiving-side negotiation method, and an order-receiving-side negotiation program.

### BACKGROUND ART

As the international competition called ANAC (International Automated Negotiating Agents Competition) is held in the prestigious international conference, the use of the technology of automated negotiating agents is currently expected.

As a technology relating to an automatic negotiation method, for example, a procurement negotiation program capable of efficiently conducting automatic negotiations on a supplier side and a seller side is described in Patent Literature (PTL) 1.

PTL 2 also describes a method for automatic negotiation with a plurality of sellers regarding a product or a service. PTL 3 also describes a method for automatic negotiation that is suitable for simultaneous negotiation with a plurality of sellers. PTL 4 also describes a method for automatic negotiation of a price of a sale item.

### CITATION LIST

### Patent Literature

PTL 1: Japanese Patent Application Laid-Open No. 2005-352702

PTL 2: U.S. Patent Application Publication No. 2004/0254846

PTL 3: U.S. Patent Application Publication No. 2004/0254875

PTL 4: U.S. Patent Application Publication No. 2014/0244404

### SUMMARY OF INVENTION

### Technical Problem

However, the technology level of the automatic negotiation method at present is still in the research stage. In other words, various improvements are required for the automatic negotiation method to be applied to an order-placing/receiving system.

For example, even in the case of executing negotiation by the automatic negotiation method, the order-placing/receiving system is not able to execute a negotiation without limit because constraints are imposed on time, resources, etc. Therefore, an order-receiving side, which is a target of the order-placing/receiving system, is required to propose an order proposal that is highly likely to be accepted by an order-placing source, which is a target of the order-placing/receiving system, as much as possible.

When the order-receiving side proposes the order proposal that has a high possibility of being accepted by the order-placing source, it is expected that the number of negotiations conducted to reach a final agreement will be less than when the possibility of being accepted by the order-placing source is not taken into account. PTLs 1 to 4 do not describe a method in which the order-receiving side proposes an order proposal that is highly likely to be accepted by the order-placing source.

### Object of Invention

Therefore, it is an object of the present invention to provide an order-receiving-side negotiation device, an order-receiving-side negotiation method, and an order-receiving-side negotiation program capable of reducing the number of negotiations conducted to reach an agreement, which solve the above-described problems.

### Solution to Problem

An order-receiving-side negotiation device according to the present invention is an order-receiving-side negotiation device for negotiating with an order-placing source who presents, to an order-receiving side that provides any product or service, an order proposal that represents a request for provision of the any product or service under predetermined negotiation conditions, includes a planning unit which prepares one or more negotiation candidates based on the predetermined negotiation conditions presented in the order proposal, an order-receiving-side's utility computation unit which computes utility values for the order-receiving side with respect to the negotiation candidates, an order-placing source's utility estimation unit which estimates utility values for the order-placing source with respect to the negotiation candidates, and a negotiation candidate determination unit which determines a negotiation candidate with respect to the order proposal from among the plurality of negotiation candidates based on both the utility values for the order-receiving side and the utility values for the order-placing source.

An order-receiving-side negotiation method according to the present invention is an order-receiving-side negotiation method implemented by an order-receiving-side negotiation device for negotiating with an order-placing source who presents, to an order-receiving side that provides any product or service, an order proposal that represents a request for provision of the any product or service under predetermined negotiation conditions, includes preparing one or more negotiation candidates based on the predetermined negotiation conditions presented in the order proposal, computing utility values for the order-receiving side with respect to the negotiation candidates, estimating utility values for the order-placing source with respect to the negotiation candidates, and determining a negotiation candidate with respect to the order proposal from among the plurality of negotiation candidates based on both the utility values for the order-receiving side and the utility values for the order-placing source.

An order-receiving-side negotiation program according to the present invention, causing a computer to execute a preparation process of preparing one or more negotiation candidates based on predetermined negotiation conditions presented in an order proposal with an order-placing source that represents a request for provision of any product or service under the predetermined negotiation conditions to an order-receiving side that provides the any product or service, a computation process of computing utility values for the order-receiving side with respect to the negotiation candidates, an estimation process of estimating utility values for the order-placing source with respect to the negotiation candidates, and a determination process of determining a negotiation candidate with respect to the order proposal from among the plurality of negotiation candidates based on both the utility values for the order-receiving side and the utility values for the order-placing source.

### Advantageous Effects of Invention

According to the present invention, it is possible to reduce the number of negotiations conducted to reach an agreement.

### BRIEF DESCRIPTION OF DRAWINGS

FIG. 1 is a block diagram showing an example of the configuration of an order-placing/receiving support system of an example embodiment of the present invention.

FIG. 2 is an explanatory diagram showing an example of a screen for inputting negotiation conditions.

FIG. 3 is a sequence diagram showing an operation of a one-to-one order-placing/receiving process by the order-placing/receiving support system 100 of this example embodiment.

FIG. 4 is a sequence diagram showing an operation of a one-to-many order-placing/receiving process by the order-placing/receiving support system 100 of this example embodiment.

FIG. 5 is a sequence diagram showing an operation of other one-to-many order-placing/receiving process by the order-placing/receiving support system 100 of this example embodiment.

FIG. 6 is an explanatory diagram showing an example of a hardware configuration of the negotiation agent according to the present invention.

FIG. 7 is a block diagram showing an overview of the order-receiving-side negotiation device according to the present invention.

### DESCRIPTION OF EMBODIMENTS

### Description of Configuration

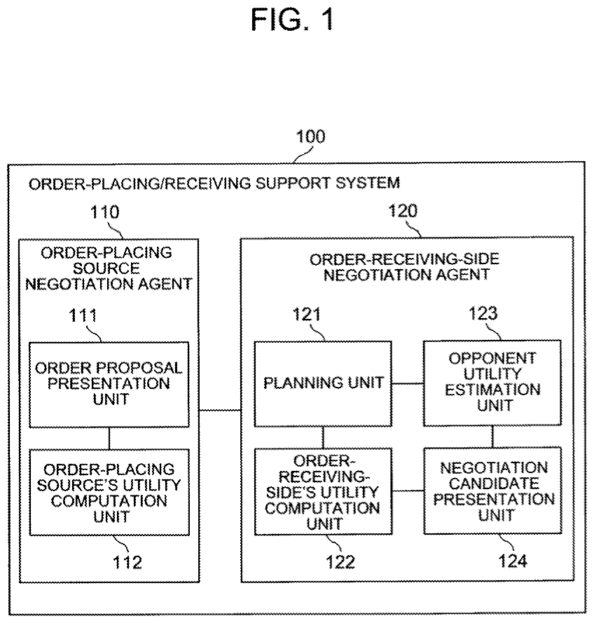

Hereinafter, an example embodiment of the present invention is described with reference to the drawings. FIG. 1 is a block diagram showing an example of the configuration of an order-placing/receiving support system of an example embodiment of the present invention.

As shown in FIG. 1, the order-placing/receiving support system 100 of the present example embodiment includes an order-placing source negotiation agent 110 and an order-receiving-side negotiation agent 120.

The order-placing source negotiation agent 110 is a negotiating agent of the order-placing source that presents an order proposal to the order-receiving side. The order-receiving-side negotiation agent 120 is a negotiating agent of the order-receiving side that provides any products or services. The order-placing/receiving support system 100 may include a plurality of order-receiving-side negotiation agent 120.

Also, as shown in FIG. 1, the order-placing source negotiation agent 110 has an order proposal presentation unit 111 and an order-placing source's utility computation unit 112.

The order proposal presentation unit 111 has a function of presenting an order proposal representing a request for provision of any products or services under predetermined negotiation conditions with respect to the order-receiving-side negotiation agent 120. The order-placing source's utility computation unit 112 has a function of computing a utility value for the order-placing source.

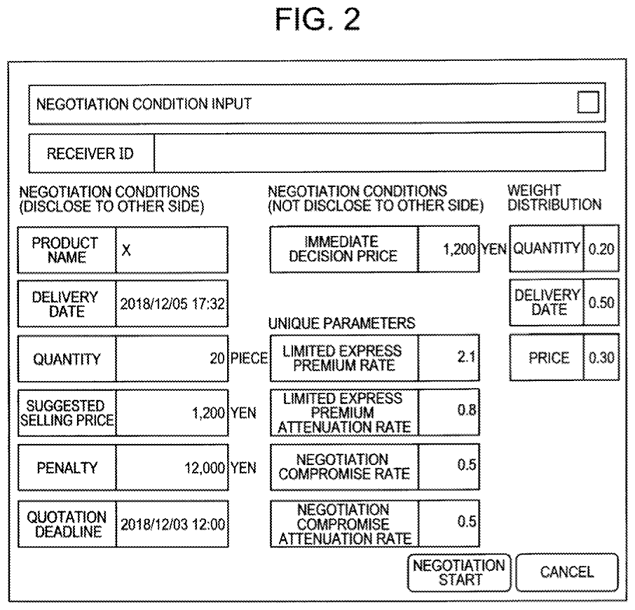

The order proposal presentation unit 111 accepts, for example, the input of various negotiation conditions of the order-placing source. FIG. 2 is an explanatory diagram showing an example of a screen for inputting negotiation conditions. In the example shown in FIG. 2, a screen for inputting negotiation conditions to be disclosed to the other side (the order-receiving side) and negotiation conditions not to be disclosed to the other side is shown. The negotiation conditions that are not disclosed to the other side are used, for example, when a determination on whether to agree or not to a negotiation candidate presented by the order-receiving side is automatically made.

In addition, as shown in FIG. 2, the order proposal presentation unit 111 accepts input, as unique parameters, of a limited express premium rate (r), a limited express premium attenuation rate (δ), a negotiation compromise rate (s), and a negotiation compromise attenuation rate (η), respectively.

The order proposal presentation unit 111 includes each of the inputted unique parameters in the order proposal. That is, the order proposal includes the limited express premium rate, the limited express premium attenuation rate, the negotiation compromise rate, and the negotiation compromise attenuation rate as respective unique parameters. Examples of the use of each unique parameter are described below.

The order proposal presentation unit 111 presents an order proposal representing a request under the inputted negotiation conditions to the order-receiving-side negotiation agent 120. The order proposal presentation unit 111 may, for example, include in the order proposal only the negotiation conditions to be disclosed to the other side among the negotiation conditions illustrated in FIG. 2.

A computation example of the utility value by the order-placing source's utility computation unit 112 is described below. The order-placing source's utility computation unit 112 computes, for example, an assumed quantity ratio q, the number of days exceeding delivery date d, and an assumed price ratio p, based on an assumed quantity, an assumed delivery date, and an assumed price, which are a quantity, a delivery date, and a price assumed by an orderer, as follows, respectively.

(Assumed quantity ratio q)=(Quantity)/(Assumed quantity)

(Number of days exceeding delivery date d)=(Delivery date)−(Assumed delivery date)

(Assumed price ratio p)=(Price)/{(Assumed price)×express}

The above-mentioned quantity, delivery date, and price are the quantity, delivery date, and price indicated by the negotiation candidate described below. In addition, the above express is computed according to the number of days remaining until the delivery date, remainingDays≥0, for example, as follows.

express=1+r×δ^{remainingDays}

However, 0.0<δ≤1.0 and r≥0.0 are the limited express premium attenuation rate and the limited express premium rate, respectively, which are unique parameters given above for each order-placing source negotiation agent 110. Next, the order-placing source's utility computation unit 112 computes, for example, the utility value u as follows.

(Utility value u)=w_{q}×q−w_{d}×d−wₚ×p

Note that w_{q}, w_{d}, and wₚ are the weights related to the assumed quantity ratio q, the number of days exceeding delivery date d, and the assumed price ratio p in the computation of the utility value, respectively.

Also, as shown in FIG. 1, the order-receiving-side negotiation agent 120 has a planning unit 121, an order-receiving-side's utility computation unit 122, an opponent utility estimation unit 123, and a negotiation candidate presentation unit 124.

The planning unit 121 has a function of preparing one or more negotiation candidates based on the predetermined negotiation conditions presented in the presented order proposal. For example, the planning unit 121 prepares one or more negotiation candidates on the basis of the presented order proposal, in which the predetermined negotiation conditions presented in the order proposal are modified. Also, the planning unit 121 may prepare negotiation candidates that include the predetermined negotiation conditions presented in the order proposal.

The order-receiving-side's utility computation unit 122 has a function for computing a utility value for the order-receiving side. For example, the order-receiving-side's utility computation unit 122 computes the utility value so that the utility of the entire production plan is improved, not only for the product for which an additional production order is placed. For example, the order-receiving-side's utility computation unit 122 computes the utility value for all orders in the production plan as follows.

(Utility value u)=Σ_{order}[(Sales)−(Delivery violation cost)−(Material cost)−(Equipment usage cost)×(Usage period)]

In computing the utility value u, the order-receiving-side's utility computation unit 122 computes the above sales, material costs, equipment usage costs, and usage periods based on information such as parts, processes, assembly schedules, inventory status, and line operating status. The order-receiving-side's utility computation unit 122 also takes into account the above-described delivery violation cost, which is a cost associated with delivery violation.

The order-receiving-side's utility computation unit 122 may compute the utility value for the order-receiving side using any one or more of the limited express premium rate, the limited express premium attenuation rate, the negotiation compromise rate, or the negotiation compromise attenuation rate included in the presented order proposal.

The opponent utility estimation unit 123 has a function to estimate a utility value for the order-placing source. The opponent utility estimation unit 123 computes an order quantity ratio q′, the number of days exceeding delivery date d′, and an order price ratio p′ based on an order quantity, an order delivery date, and an order price, which are a quantity, a delivery date, and a price ordered by the first orderer, as follows, respectively.

(Order quantity ratio q′)=(Quantity)/(Order quantity)

(Number of days exceeding delivery date d′)=(Delivery date)−(Order delivery date)

(Order price ratio p′)=(Price)/{(Order price)×express′}

The above-mentioned quantity, delivery date, and price are the quantity, delivery date, and price indicated by the negotiation candidate. If the order price is not specified by the orderer, the opponent utility estimation unit 123 may use the standard price unique to the order-receiving side instead of the order price. In addition, the above express′ is computed according to the number of days remaining until the delivery date, remainingDays≥0, for example, as follows.

express′=1+r′×δ′^{remainingDays}

However, 0.0<δ′≤1.0 and r′≥0.0 are constants given to each order-receiving-side negotiation agent 120. The opponent utility estimation unit 123 may use the limited express premium attenuation rate and the limited express premium rate included in the presented order proposal as δ′ and r′, respectively. Next, the opponent utility estimation unit 123 estimates, for example, the utility value u′ as follows.

(Utility value u′)=w_{q}′×q′−w_{d}′×d′−wₚp′

Note that w_{q}′, w_{d}′, and wₚ′ are the weights related to the order quantity ratio q′, the number of days exceeding delivery date d′, and the order price ratio p′ in the computation of the utility value, respectively.

The opponent utility estimation unit 123 may estimate the utility value for the order-placing source using the negotiation compromise rate and the negotiation compromise attenuation rate included in the presented order proposal. That is, the opponent utility estimation unit 123 may estimate the utility value for the order-placing source using any one or more of the limited express premium rate, the limited express premium attenuation rate, the negotiation compromise rate, or the negotiation compromise attenuation rate included in the presented order proposal.

The opponent utility estimation unit 123 may estimate the utility value for the order-placing source using the function f(x₁, x₂, . . . , xₙ)=a₁*x₁+a₂*x₂+. . . +aₙ*xₙ. As an example of a case in which the function f is used, consider a case in which the prepared negotiation candidates are (x₁¹, x₂¹, . . . , xₙ¹) for the first time, (x₁², x₂², . . . , xₙ²) for the second time, and (x₁³, x₂³, . . . , xₙ³) for the third time.

f(x₁¹, x₂¹, . . . , xₙ¹)>f(x₁², x₂², . . . , xₙ²)>(x₁³, x₂³, . . . , xₙ³)>f(other)

So that the utility value for the order-placing source satisfies the above formula as much as possible, the opponent utility estimation unit 123 adjusts the coefficients a₁, a₂, . . . , aₙ of the function f by a machine learning, respectively. The machine learning is, for example, supervised learning, unsupervised learning, and reinforcement learning. The function f may be any function other than a linear function.

The negotiation candidate presentation unit 124 has a function for determining a negotiation candidate with respect to the presented order proposal from among the prepared negotiation candidates, and presenting the negotiation candidate to the order-placing source negotiation agent 110. The method of determining the negotiation candidate is described below.

The order-receiving-side negotiation agent 120 of this example embodiment has a function for estimating a utility value for the order-placing source with respect to the negotiation candidate, that is, a function for estimating whether or not the order-placing source is likely to accept the negotiation candidate. The order-receiving-side negotiation agent 120 preferentially presents a negotiation candidate that is likely to be accepted by the order-placing source and that also has favorable conditions for the order-receiving side.

### Description of Operation

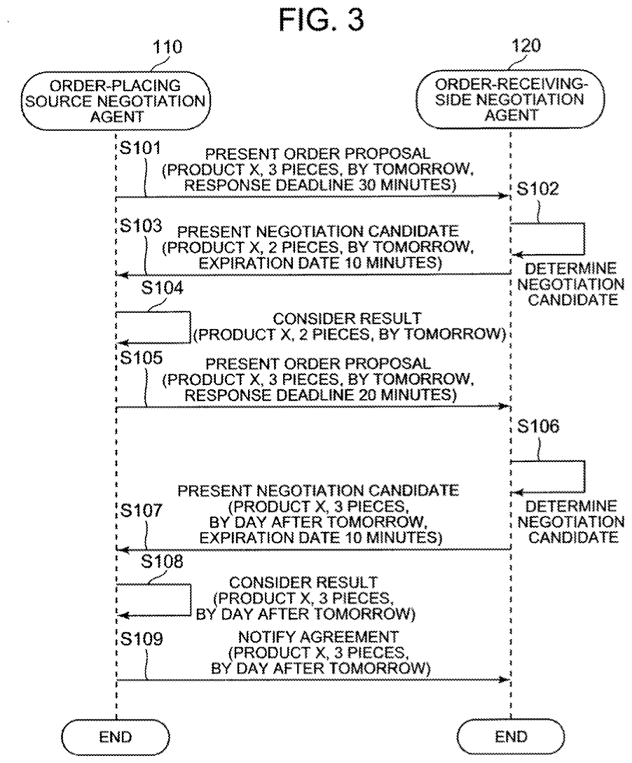

Hereinafter, the operation of the order-placing/receiving support system 100 of the present example embodiment is described below with reference to FIGS. 3 to 5.

First, the order-placing/receiving process in the case where (order-placing source: order-receiving side)=(1:1) will be described. FIG. 3 is a sequence diagram showing an operation of a one-to-one order-placing/receiving process by the order-placing/receiving support system 100 of this example embodiment.

The order proposal presentation unit 111 presents an order proposal to the order-receiving-side negotiation agent 120, specifying a product, a quantity, a delivery date, and a response deadline, respectively (step S101). As shown in FIG. 3, the order proposal presentation unit 111 presents, for example, an order proposal in which the negotiation conditions are “product X, 3 pieces, by tomorrow and the response deadline is 30 minutes”.

The order proposal presentation unit 111 waits until a response is received. If the response is not received by the response deadline, the order proposal presentation unit 111 considers the negotiation unsuccessful.

The planning unit 121 of the order-receiving-side negotiation agent 120 that is presented with the order proposal by the order-placing source negotiation agent 110 prepares one or more negotiation candidates based on the presented order proposal, in which the negotiation conditions presented in the order proposal are modified.

Next, the order-receiving-side's utility computation unit 122 computes a utility value for the order-receiving side with respect to the prepared negotiation candidate. Next, the opponent utility estimation unit 123 estimates a utility value for the order-placing source with respect to the prepared negotiation candidate.

Next, the negotiation candidate presentation unit 124 considers the plurality of prepared negotiation candidates in order using the utility value for the order-receiving side and the estimated utility value for the order-placing source.

For example, the negotiation candidate presentation unit 124 determines the negotiation candidate for which (utility value u for the order-receiving side)×(estimated utility value u′ for the order-placing source) is the largest as a negotiation candidate with respect to the order proposal (step S102). Next, the negotiation candidate presentation unit 124 presents the determined negotiation candidate to the order-placing source negotiation agent 110.

Next, the order proposal presentation unit 111 receives the negotiation candidates (step S103). As shown in FIG. 3, the order proposal presentation unit 111 receives a negotiation candidate with an expiration date of 10 minutes, “product X, 2 pieces, by tomorrow”.

Next, the order-placing source's utility computation unit 112 considers whether the utility value of the received negotiation candidate exceeds a threshold value (step S104). If the utility value of the received negotiation candidate do not exceed the threshold value, the order proposal presentation unit 111 presents the order proposal again to the order-receiving-side negotiation agent 120 that presented the negotiation candidate without changing the conditions (step S105). The value used for the comparison with the threshold value may be a value related to the negotiation candidate other than the utility value.

The negotiation candidate presentation unit 124 presents a new negotiation candidate to the order-placing source negotiation agent 110 using the utility value for the order-receiving side and the estimated utility value for the order-placing source (step S106).

The order proposal presentation unit 111 again receives the negotiation candidate (“product X, 3 pieces, by day after tomorrow”) (step S107). The order-placing source's utility computation unit 112 considers whether the utility value of the received negotiation candidate exceeds a threshold value (step S108).

If the utility value of the received negotiation candidate exceed the threshold value, the order proposal presentation unit 111 agrees with the order-receiving-side negotiation agent 120 regarding the negotiation candidate (step S109). After the agreement is reached, the order-placing/receiving support system 100 terminates the order-placing/receiving process.

The order proposal presentation unit 111 may lower the above threshold value in accordance with the remaining negotiation time negotiationTimeLeft. The threshold value is computed, for example, as follows.

(Threshold value)=(First assumed threshold value)×(1−s×η^{negotiationTimeLeft})

Note that s and η are the negotiation compromise rate and the negotiation compromise attenuation rate, respectively, which are the in unique parameters described above. s and η are 0.0<η≤1.0 and 0.0≤s<1.0, respectively. Depending on the settings of s and η, the threshold value may not be lowered according to the negotiationTimeLeft.

A case in which it is preferable for the order-placing source negotiation agent 110 to lower the threshold value is, for example, a case in which there is no alternative order-receiving side from the viewpoint of the order-placing source. A case in which it is preferable for the order-placing source negotiation agent 110 not to lower the threshold value is, for example, a case in which, from the viewpoint of the order-placing source, there are many alternative order-receiving sides, but from the viewpoint of the order-receiving side, there are not many alternative order-placing sources.

Next, two ways of an order-placing/receiving process when (order-placing source: order-receiving side)=(1:k) (k is a natural number greater than or equal to 2), i.e., when multiple quotes are made will be described.

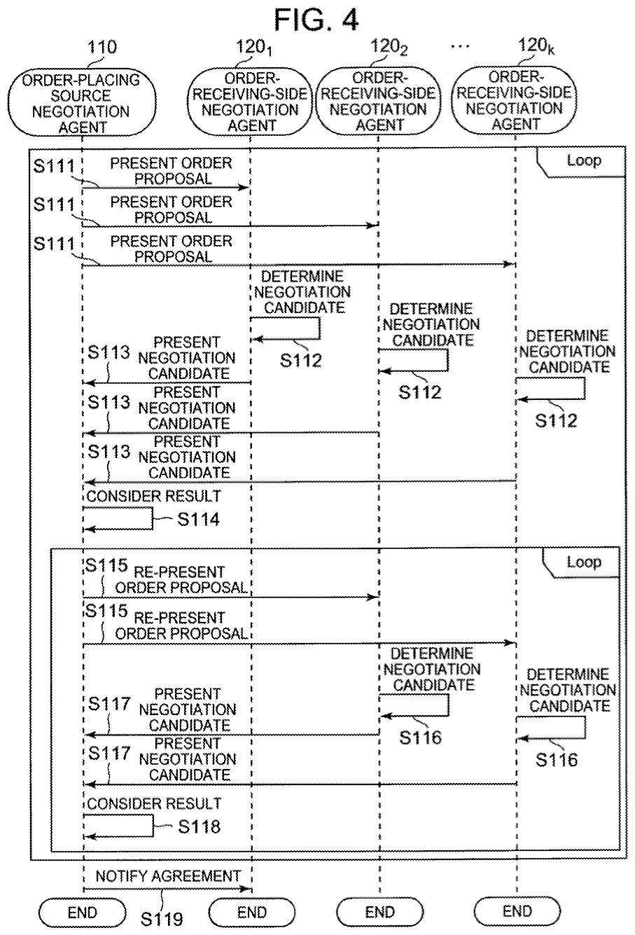

FIG. 4 is a sequence diagram showing an operation of a one-to-many order-placing/receiving process by the order-placing/receiving support system 100 of this example embodiment. The first method shown in FIG. 4 is a method in which the order-placing source negotiation agent 110 presents an order proposal to the order-receiving-side negotiation agent 120₁ to the order-receiving-side negotiation agent 120ₖ at the same time.

The order proposal presentation unit 111 specifies a product, a quantity, a delivery date, and a response deadline, respectively, and presents an order proposal to the order-receiving-side negotiation agent 120₁ to the order-receiving-side negotiation agent 120ₖ (step S111). The order proposal presentation unit 111 waits until k negotiation candidates are received.

The planning unit 121 of each order-receiving-side negotiation agent which is presented with the order proposal from the order-placing source negotiation agent 110, prepares a negotiation candidate for each of the plurality of negotiation conditions.

For example, the planning unit 121 prepares a negotiation candidate for each combination of negotiation conditions for which the following values are computed. In other words, the planning unit 121 prepares (L×M×N) candidates (L, M, and N are natural numbers, respectively).

1. Candidates with relaxed delivery conditions (extended delivery): d′=0, 1, 2, . . . , L

2. Candidates with relaxed quantity conditions (quantity reduction): q′=1.0, 1.0-a, 1.0-2a, . . . , 1.0-Ma (a is an arbitrary constant)

3. Candidates with relaxed price conditions (increased price): p′=1.0, 1.0-b, 1.0-2b, . . . , 1.0-Nb (b is an arbitrary constant)

Since prices are not used in the simulation, the planning unit 121 only needs to prepare (L×M) negotiation candidates.

Next, the negotiation candidate presentation unit 124 considers the plurality of prepared negotiation candidates in order using the utility value for the order-receiving side and the estimated utility value for the order-placing source. For example, the negotiation candidate presentation unit 124 determines the negotiation candidate for which {(utility value u for the order-receiving side)×(estimated utility value u′ for the order-placing source)} is the largest as a negotiation candidate with respect to the order proposal (step S112). Next, the negotiation candidate presentation unit 124 presents the determined negotiation candidate to the order-placing source negotiation agent 110.

In the case where the negotiation period is long, the planning unit 121 may update the negotiation candidate every predetermined time (for example, 2 hours) because the time when the negotiation is resumed is unknown.

The order proposal presentation unit 111 receives each of the k negotiation candidates (step S113). After the k negotiation candidates are received, the order-placing source's utility computation unit 112 considers the k negotiation candidates (step S114). Specifically, the order-placing source's utility computation unit 112 computes the utility values of each of the k negotiation candidates. Then, the order-placing source's utility computation unit 112 sets the largest utility value among the computed utility values to be uₘₐₓ.

The order proposal presentation unit 111 withholds a response to the order-receiving-side negotiation agent 120 that presented a negotiation candidate whose utility value is uₘₐₓ, and presents the order proposal again to the other (k−1) order-receiving-side negotiation agent 120 without changing the conditions (step S115).

The negotiation candidate presentation unit 124 of the (k−1) order-receiving-side negotiation agents that are presented with the order proposal by the order-placing source negotiation agent 110 presents one negotiation candidate each using the utility value for the order-receiving side and the estimated utility value for the order-placing source (step S116).

The order proposal presentation unit 111 receives each of the (k−1) negotiation candidates (step S117). After the (k−1) negotiation candidates are received, the order-placing source's utility computation unit 112 considers the (k−1) negotiation candidates (step S118). Specifically, the order-placing source's utility computation unit 112 computes the utility values of each of the (k−1) negotiation candidates.

Next, the order-placing source's utility computation unit 112 sets the largest utility value as the new uₘₐₓ if the largest utility value among the computed utility values exceeds uₘₐₓ. Next, the order proposal presentation unit 111 executes the step S115 again.

If the largest utility value among the computed utility values does not exceed uₘₐₓ, the order proposal presentation unit 111 executes the step S111 again. After the processes of steps S111 to S118 are repeated a predetermined number of times, the order proposal presentation unit 111 reaches an agreement with the order-receiving-side negotiation agent 120 that presented the negotiation candidate whose utility value is uₘₐₓ with respect to the negotiation candidate (step S119).

After reaching an agreement, the order proposal presentation unit 111 notifies the other order-receiving-side negotiation agent 120 that the negotiation has been terminated. After the notification, the order-placing/receiving support system 100 terminates the order-placing/receiving process.

In the example shown in FIG. 4, the value used for uₘₐₓ may be any value related to the negotiation candidate other than the utility value.

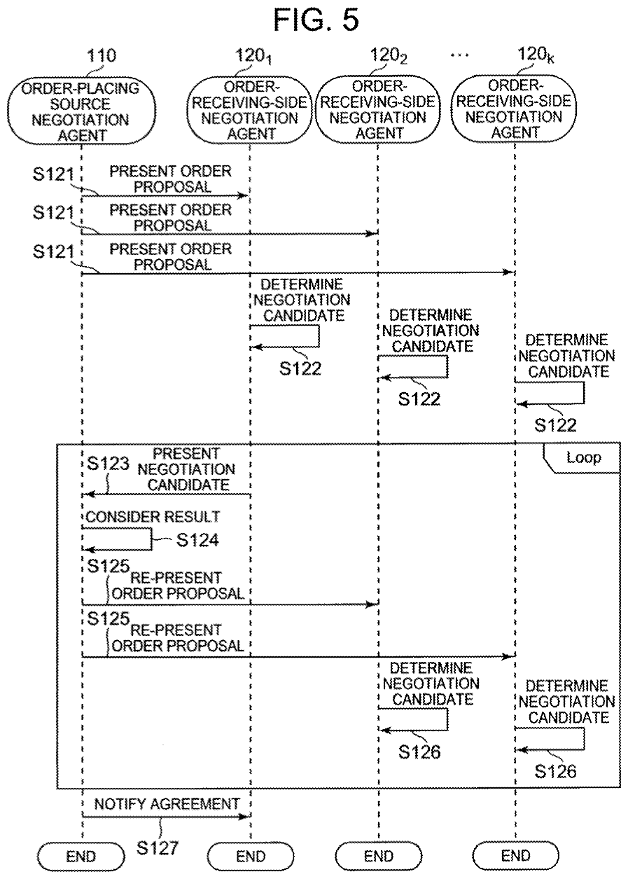

FIG. 5 is a sequence diagram showing an operation of other one-to-many order-placing/receiving process by the order-placing/receiving support system 100 of this example embodiment. The second method shown in FIG. 5 is a method in which the order-placing source negotiation agent 110 presents a different order proposal to the order-receiving-side negotiation agent 120₁ to the order-receiving-side negotiation agent 120ₖ.

By varying the negotiation condition, the order-placing source negotiation agent 110 may receive a more preferred negotiation candidate. If there is only one order-receiving-side negotiation agent 120 that has discovered a negotiation condition under which a more preferred negotiation candidate is presented, the order-placing source negotiation agent 110 may prefer to present the order proposal with the discovered negotiation condition to the other order-receiving-side negotiation agent 120 as well.

In order to prevent the order-receiving-side negotiation agent 120 that responded earlier from suffering a unilateral loss, the order-placing source negotiation agent 110 declares that it will give another opportunity to negotiate before agreeing with the other order-receiving-side negotiation agent 120. The order-placing/receiving process shown in FIG. 5 is described in detail below.

The order proposal presentation unit 111 specifies a product, a quantity, a delivery date, and a response deadline, respectively, and presents an order proposal to the order-receiving-side negotiation agent 120₁ to the order-receiving-side negotiation agent 120ₖ (step S121). After presenting the order proposal, the order proposal presentation unit 111 sets the requested flag of each order-receiving-side negotiation agent to TRUE.

Also, the order proposal presentation unit 111 sets uₘₐₓ:=(worst value). In order to prevent the order-receiving-side negotiation agent 120 that responded earlier from suffering a unilateral loss, the order proposal presentation unit 111 declares that it will be given an opportunity to negotiate once before agreeing with the other order-receiving-side negotiation agent 120.

The process in which the negotiation candidate presentation unit 124 of each order-receiving-side negotiation agent presents a negotiation candidate in step S122 is the same as the process in step S112.

The order proposal presentation unit 111 waits until the negotiation candidate is received. Once the negotiation candidate is received (step S123), the order proposal presentation unit 111 proceeds to step S124. If the response deadline is reached before the negotiation candidate is received, the order proposal presentation unit 111 proceeds to step S127.

In step S124, the order-placing source's utility computation unit 112 considers the negotiation candidate. Specifically, the order-placing source's utility computation unit 112 computes a utility value u of the received negotiation candidate.

When the computed utility value u exceeds the largest utility value uₘₐₓ at the present time, the order-placing source's utility computation unit 112 sets uₘₐₓ:=u. In addition, the order-placing source's utility computation unit 112 sets the requested flag of the order-receiving-side negotiation agent 120 other than the order-receiving-side negotiation agent 120 that presented the negotiation candidate whose utility value is uₘₐₓ to FALSE.

If there is an order-receiving-side negotiation agent 120 whose requested flag is FALSE, the order proposal presentation unit 111 presents the order proposal again to each order-receiving-side negotiation agent under the same conditions as the negotiation conditions for the prepared negotiation candidate which the utility value is uₘₐₓ. After presenting the order proposal, the order proposal presentation unit 111 sets the requested flag of each order-receiving-side negotiation agent to TRUE, and returns to step S123.

If there is no order-receiving-side negotiation agent 120 whose requested flag is FALSE, the order proposal presentation unit 111 proceeds to step S127.

The process in which the negotiation candidate presentation unit 124 of each order-receiving-side negotiation agent presents a negotiation candidate in step S126 is the same as the process in step S122.

In step S127, the order proposal presentation unit 111 agrees with the order-receiving-side negotiation agent 120 that presented the negotiation candidate whose utility value is uₘₐₓ on the negotiation candidate. After reaching the agreement, the order proposal presentation unit 111 notifies the other order-receiving-side negotiation agent 120 that the negotiation has been completed. After the notification, the order-placing/receiving support system 100 terminates the order-placing/receiving process.

As described above, there may be a case where it is declared by the order-placing source negotiation agent 110 to give an opportunity for negotiation once before agreeing with another company. In the case where it is declared to give an opportunity for negotiation once before agreeing with another company, the negotiation candidate presentation unit 124 should respond to the negotiation candidate once a negotiation candidate satisfactory to some extent is obtained, even before a sufficiently explored negotiation candidate is obtained.

In addition, if it has not been declared by the order-placing source negotiation agent 110 to give an opportunity to negotiate once before agreeing with another company, the negotiation candidate presentation unit 124 should not respond with a negotiation candidate until a sufficiently explored negotiation candidate has been obtained.

The negotiation candidate presentation unit 124 may compute the closeness between the negotiation contents of the first, second, . . . in the past negotiation history and the negotiation candidate, and present the negotiation candidate that is closest to the past negotiation history.

The negotiation candidate presentation unit 124 computes the closeness between the past negotiation history and the negotiation candidates by, for example, taking a sum-of-squares square root. The negotiation candidate presentation unit 124 may also compute the closeness by considering the similarity of each situation (such as the weather) of the past negotiation history and the negotiation candidate. That is, the negotiation candidate presentation unit 124 may determine a negotiation candidate that is most similar to the past negotiation candidate as a negotiation candidate with respect to the order proposal.

### Description of Effect

The opponent utility estimation unit 123 of the order-receiving-side negotiation agent 120 of this example embodiment estimates a utility value of a negotiation opponent. Also, the negotiation candidate presentation unit 124 preferentially presents a negotiation candidate that are also highly effective for the order-placing source using the estimated utility value. Accordingly, the order-receiving-side negotiation agent 120 can reach an agreement with the order-placing source negotiation agent 110 on the negotiation candidate with a smaller number of times.

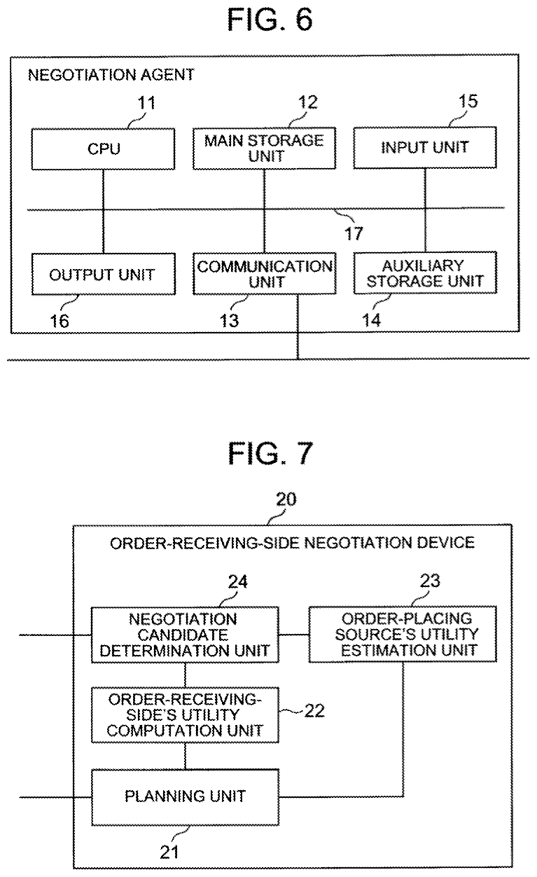

A specific example of a hardware configuration of the negotiation agent according to the present example embodiment will be described below. FIG. 6 is an explanatory diagram showing an example of a hardware configuration of the negotiation agent according to the present invention.

The negotiation agent shown in FIG. 6 correspond to the order-placing source negotiation agent 110 and the order-receiving-side negotiation agent 120 of this example embodiment.

The negotiation agent shown in FIG. 6 includes a CPU (Central Processing Unit) 11, a main storage unit 12, a communication unit 13, and an auxiliary storage unit 14. The negotiation agent also includes an input unit 15 for the user to operate and an output unit 16 for presenting a processing result or a progress of the processing contents to the user.

The negotiation agent is realized by software, with the CPU 11 shown in FIG. 6 executing a program that provides a function that each component has.

Specifically, each function is realized by software as the CPU 11 loads the program stored in the auxiliary storage unit 14 into the main storage unit 12 and executes it to control the operation of the negotiation agent.

The negotiation agent shown in FIG. 6 may include a DSP (Digital Signal

Processor) instead of the CPU 11. Alternatively, the negotiation agent shown in FIG. 6 may include both the CPU 11 and the DSP.

The main storage unit 12 is used as a work area for data and a temporary save area for data. The main storage unit 12 is, for example, RAM (Random Access Memory).

The communication unit 13 has a function of inputting and outputting data to and from peripheral devices through a wired network or a wireless network (information communication network).

The auxiliary storage unit 14 is a non-transitory tangible medium. Examples of non-transitory tangible media are, for example, a magnetic disk, an optical magnetic disk, a CD-ROM (Compact Disk Read Only Memory), a DVD-ROM (Digital Versatile Disk Read Only Memory), a semiconductor memory.

The input unit 15 has a function of inputting data and processing instructions. The input unit 15 is, for example, an input device such as a keyboard or a mouse.

The output unit 16 has a function to output data. The output unit 16 is, for example, a display device such as a liquid crystal display device, or a printing device such as a printer.

As shown in FIG. 6, in the negotiation agent, each component is connected to the system bus 17.

The auxiliary storage unit 14 stores programs for realizing the order proposal presentation unit 111 and the order-placing source's utility computation unit 112 in the order-placing source negotiation agent 110 of this example embodiment.

The auxiliary storage unit 14 stores programs for realizing the planning unit 121, the order-receiving-side's utility computation unit 122, the opponent utility estimation unit 123, and the negotiation candidate presentation unit 124 in the order-receiving-side negotiation agent 120 of this example embodiment.

The negotiation agent may be implemented with a circuit that contains hardware components inside such as an LSI (Large Scale Integration) that realize the functions shown in FIG. 1, for example.

The negotiation agent may be realized by hardware that does not include computer functions using elements such as a CPU. For example, some or all of the components may be realized by a general-purpose circuit (circuitry) or a dedicated circuit, a processor, or a combination of these. They may be configured by a single chip (for example, the LSI described above) or by multiple chips connected via a bus. Some or all of the components may be realized by a combination of the above-mentioned circuit, etc. and a program.

In the case where some or all of the components are realized by a plurality of information processing devices, circuits, or the like, the plurality of information processing devices, circuits, or the like may be centrally located or distributed. For example, the information processing devices, circuits, etc. may be realized as a client-server system, a cloud computing system, etc., each of which is connected via a communication network.

Next, an overview of the present invention will be described. FIG. 7 is a block diagram showing an overview of the order-receiving-side negotiation device according to the present invention. The order-receiving-side negotiation device 20 according to the present invention is an order-receiving-side negotiation device (for example, the order-receiving-side negotiation agent 120) for negotiating with an order-placing source who presents, to an order-receiving side that provides any product or service, an order proposal that represents a request for provision of the any product or service under predetermined negotiation conditions, includes a planning unit 21 (for example, the planning unit 121) which prepares one or more negotiation candidates based on the predetermined negotiation conditions presented in the order proposal, an order-receiving-side's utility computation unit 22 (for example, the order-receiving-side's utility computation unit 122) which computes utility values for the order-receiving side with respect to the negotiation candidates, an order-placing source's utility estimation unit 23 (for example, the opponent utility estimation unit 123) which estimates utility values for the order-placing source with respect to the negotiation candidates, and a negotiation candidate determination unit 24 (for example, the negotiation candidate presentation unit 124) which determines a negotiation candidate with respect to the order proposal from among the plurality of negotiation candidates based on both the utility values for the order-receiving side and the utility values for the order-placing source.

With such a configuration, the order-receiving-side negotiation device can reduce the number of negotiations conducted to reach an agreement.

The planning unit 21 may generate a plurality of conditions under which the predetermined negotiation conditions presented in the order proposal are relaxed, and may prepare the negotiation candidates using the generated conditions.

With such a configuration, the order-receiving-side negotiation device can prepare a plurality of negotiation candidates based on the order proposal.

The order-placing source's utility estimation unit 23 may estimate the utility values for the order-placing source using a utility function, and may adjust coefficients of the utility function by machine learning.

With such a configuration, the order-receiving-side negotiation device can adjust the utility values by the machine learning.

The negotiation candidate determination unit 24 may determine a negotiation candidate whose product of the utility value for the order-receiving side and the utility value for the order-placing source is the largest as the negotiation candidate with respect to the order proposal.

With such a configuration, the order-receiving-side negotiation device can further reduce the number of negotiations conducted to reach an agreement.

The negotiation candidate determination unit 24 may determine a negotiation candidate that is most similar to the past negotiation candidate as the negotiation candidate with respect to the order proposal.

With such a configuration, the order-receiving-side negotiation device can further reduce the number of negotiations conducted to reach an agreement.

The predetermined negotiation conditions may be conditions related to a quantity, a delivery date, and a price.

With such a configuration, the order-receiving-side negotiation device can prepare a plurality of negotiation candidates in which the order quantity, delivery date, and order price are relaxed.

The order proposal may include a limited express premium rate, a limited express premium attenuation rate, a negotiation compromise rate, and a negotiation compromise attenuation rate as unique parameters, respectively.

With such a configuration, the order-receiving-side negotiation device can reflect the requirements of the order-placing source in the negotiations in more detail.

The order-receiving-side's utility computation unit may compute the utility values for the order-receiving side using one or more of the limited express premium rate, the limited express premium attenuation rate, the negotiation compromise rate, or the negotiation compromise attenuation rate included in the order proposal.

With such a configuration, the order-receiving-side negotiation device can reflect the requirements of the order-placing source in the utility values for the order-receiving side in more detail.

The order-placing source's utility estimation unit may estimate the utility values for the order-placing source using one or more of the limited express premium rate, the limited express premium attenuation rate, the negotiation compromise rate, or the negotiation compromise attenuation rate included in the order proposal.

With such a configuration, the order-receiving-side negotiation device can reflect the requirements of the order-placing source in the utility values for the order-placing source in more detail.

While the present invention has been explained with reference to the example embodiments, the present invention is not limited to the aforementioned example embodiments. Various changes understandable to those skilled in the art within the scope of the present invention can be made to the structures and details of the present invention.

Some or all of the aforementioned example embodiment can be described as supplementary notes mentioned below, but are not limited to the following supplementary notes.

(Supplementary note 1) An order-receiving-side negotiation device for negotiating with an order-placing source who presents, to an order-receiving side that provides any product or service, an order proposal that represents a request for provision of the any product or service under predetermined negotiation conditions, comprising: a planning unit which prepares one or more negotiation candidates based on the predetermined negotiation conditions presented in the order proposal; an order-receiving-side's utility computation unit which computes utility values for the order-receiving side with respect to the negotiation candidates; an order-placing source's utility estimation unit which estimates utility values for the order-placing source with respect to the negotiation candidates; and a negotiation candidate determination unit which determines a negotiation candidate with respect to the order proposal from among the plurality of negotiation candidates based on both the utility values for the order-receiving side and the utility values for the order-placing source.

(Supplementary note 2) The order-receiving-side negotiation device according to Supplementary note 1, wherein the planning unit generates a plurality of conditions under which the predetermined negotiation conditions presented in the order proposal are relaxed, and prepares the negotiation candidates using the generated conditions.

(Supplementary note 3) The order-receiving-side negotiation device according to Supplementary note 1 or 2, wherein the order-placing source's utility estimation unit estimates the utility values for the order-placing source using a utility function, and adjusts coefficients of the utility function by machine learning.

(Supplementary note 4) The order-receiving-side negotiation device according to any one of Supplementary notes 1 to 3, wherein the negotiation candidate determination unit determines a negotiation candidate whose product of the utility value for the order-receiving side and the utility value for the order-placing source is the largest as the negotiation candidate with respect to the order proposal.

(Supplementary note 5) The order-receiving-side negotiation device according to any one of Supplementary notes 1 to 3, wherein the negotiation candidate determination unit determines a negotiation candidate that is most similar to the past negotiation candidate as the negotiation candidate with respect to the order proposal.

(Supplementary note 6) The order-receiving-side negotiation device according to any one of Supplementary notes 1 to 5, wherein the predetermined negotiation conditions are conditions related to a quantity, a delivery date, and a price.

(Supplementary note 7) The order-receiving-side negotiation device according to any one of Supplementary notes 1 to 6, wherein the order proposal includes a limited express premium rate, a limited express premium attenuation rate, a negotiation compromise rate, and a negotiation compromise attenuation rate as unique parameters, respectively.

(Supplementary note 8) The order-receiving-side negotiation device according to Supplementary note 7, wherein the order-receiving-side's utility computation unit computes the utility values for the order-receiving side using one or more of the limited express premium rate, the limited express premium attenuation rate, the negotiation compromise rate, or the negotiation compromise attenuation rate included in the order proposal.

(Supplementary note 9) The order-receiving-side negotiation device according to Supplementary note 7 or 8, wherein the order-placing source's utility estimation unit estimates the utility values for the order-placing source using one or more of the limited express premium rate, the limited express premium attenuation rate, the negotiation compromise rate, or the negotiation compromise attenuation rate included in the order proposal.

(Supplementary note 10) An order-receiving-side negotiation method implemented by an order-receiving-side negotiation device for negotiating with an order-placing source who presents, to an order-receiving side that provides any product or service, an order proposal that represents a request for provision of the any product or service under predetermined negotiation conditions, comprising: preparing one or more negotiation candidates based on the predetermined negotiation conditions presented in the order proposal; computing utility values for the order-receiving side with respect to the negotiation candidates; estimating utility values for the order-placing source with respect to the negotiation candidates; and determining a negotiation candidate with respect to the order proposal from among the plurality of negotiation candidates based on both the utility values for the order-receiving side and the utility values for the order-placing source.

(Supplementary note 11) The order-receiving-side negotiation method according to Supplementary note 10, further comprising: generating a plurality of conditions under which the predetermined negotiation conditions presented in the order proposal are relaxed; and preparing the negotiation candidates using the generated conditions.

(Supplementary note 12) An order-receiving-side negotiation program causing a computer to execute: a preparation process of preparing one or more negotiation candidates based on predetermined negotiation conditions presented in an order proposal with an order-placing source that represents a request for provision of any product or service under the predetermined negotiation conditions to an order-receiving side that provides the any product or service; a computation process of computing utility values for the order-receiving side with respect to the negotiation candidates; an estimation process of estimating utility values for the order-placing source with respect to the negotiation candidates; and a determination process of determining a negotiation candidate with respect to the order proposal from among the plurality of negotiation candidates based on both the utility values for the order-receiving side and the utility values for the order-placing source.

(Supplementary note 13) The order-receiving-side negotiation program according to Supplementary note 12, causing the computer to execute: a generation process of generating a plurality of conditions under which the predetermined negotiation conditions presented in the order proposal are relaxed, wherein the order-receiving-side negotiation program causes the computer to prepare the negotiation candidates using the generated conditions, in the preparation process.

### INDUSTRIAL APPLICABILITY

The present invention is suitably applied to an order-placing/receiving support method or a negotiation method which efficiently automates or semi-automates negotiations between an order-placing source and an order-receiving side related to such as a delivery date, a quantity, or a price.

### REFERENCE SIGNS LIST

11 CPU
12 Main storage unit
13 Communication unit
14 Auxiliary storage unit
15 Input unit
16 Output unit
17 System bus
20 Order-receiving-side negotiation device
21, 121 Planning unit
22, 122 Order-receiving-side's utility computation unit
23 Order-placing source's utility estimation unit
24 Negotiation candidate determination unit
100 Order-placing/receiving support system
110 Order-placing source negotiation agent
111 Order proposal presentation unit
112 Order-placing source's utility computation unit
120, 120₁˜120ₖ Order-receiving-side negotiation agent
123 Opponent utility estimation unit
124 Negotiation candidate presentation unit

What is claimed is:

1. An order-receiving-side negotiation device, comprising:
a processor; and
a memory storing a program executed by the processor;
the program including steps of:
preparing one or more negotiation candidates based on predetermined negotiation conditions presented in an order proposal, the order proposal indicating a request for provision of any product or service;
computing utility values for an order-receiving side with respect to the negotiation candidates, the order-receiving side providing any product or service;
estimating utility values for an order-placing source with respect to the negotiation candidates; and
determining a negotiation candidate with respect to the order proposal from among the plurality of negotiation candidates based on both the utility values for the order-receiving side and the utility values for the order-placing source.

2. The order-receiving-side negotiation device according to claim 1, wherein
the program including steps of:
generating a plurality of conditions under which the predetermined negotiation conditions presented in the order proposal are relaxed; and
preparing the negotiation candidates using the generated conditions.

3. The order-receiving-side negotiation device according to claim 1, wherein
the program including steps of:
estimating the utility values for the order-placing source using a utility function; and
adjusting coefficients of the utility function by machine learning.

4. The order-receiving-side negotiation device according to claim 1, wherein
the program including step of determining a negotiation candidate whose product of the utility value for the order-receiving side and the utility value for the order-placing source is the largest as the negotiation candidate with respect to the order proposal.

5. The order-receiving-side negotiation device according to claim 1, wherein
the program including step of determining a negotiation candidate that is most similar to the past negotiation candidate as the negotiation candidate with respect to the order proposal.

6. The order-receiving-side negotiation device according to claim 1, wherein
the predetermined negotiation conditions are conditions related to a quantity, a delivery date, and a price.

7. The order-receiving-side negotiation device according to claim 1, wherein
the order proposal includes a limited express premium rate, a limited express premium attenuation rate, a negotiation compromise rate, and a negotiation compromise attenuation rate as unique parameters, respectively.

8. The order-receiving-side negotiation device according to claim 7, wherein the program including step of computing the utility values for the order-receiving side using one or more of the limited express premium rate, the limited express premium attenuation rate, the negotiation compromise rate, or the negotiation compromise attenuation rate included in the order proposal.

9. The order-receiving-side negotiation device according to claim 7, wherein
the program including step of estimating the utility values for the order-placing source using one or more of the limited express premium rate, the limited express premium attenuation rate, the negotiation compromise rate, or the negotiation compromise attenuation rate included in the order proposal.

10. An order-receiving-side negotiation method implemented by an order-receiving-side negotiation device, comprising:
preparing one or more negotiation candidates based on predetermined negotiation conditions presented in an order proposal, the order proposal indicating a request for provision of any product or service;
computing utility values for the an order-receiving side with respect to the negotiation candidates, the order-receiving side providing any product or service;
estimating utility values for an order-placing source with respect to the negotiation candidates; and
determining a negotiation candidate with respect to the order proposal from among the plurality of negotiation candidates based on both the utility values for the order-receiving side and the utility values for the order-placing source.

11. The order-receiving-side negotiation method according to claim 10, further comprising:
generating a plurality of conditions under which the predetermined negotiation conditions presented in the order proposal are relaxed; and
preparing the negotiation candidates using the generated conditions.

12. A non-transitory computer-readable recording medium recording an order-receiving-side negotiation program causing a computer to execute:
a preparation process of preparing one or more negotiation candidates based on predetermined negotiation conditions presented in an order proposal with an order-placing source that represents a request for provision of any product or service under the predetermined negotiation conditions to an order-receiving side that provides the any product or service;
a computation process of computing utility values for the order-receiving side with respect to the negotiation candidates;
an estimation process of estimating utility values for the order-placing source with respect to the negotiation candidates; and
a determination process of determining a negotiation candidate with respect to the order proposal from among the plurality of negotiation candidates based on both the utility values for the order-receiving side and the utility values for the order-placing source.

13. The recording medium according to claim 12, causing the computer to execute:
a generation process of generating a plurality of conditions under which the predetermined negotiation conditions presented in the order proposal are relaxed,
wherein the order-receiving-side negotiation program causes the computer to prepare the negotiation candidates using the generated conditions, in the preparation process.

14. The order-receiving-side negotiation device according to claim 2, wherein
the program including steps of:
estimating the utility values for the order-placing source using a utility function; and
adjusting coefficients of the utility function by machine learning.

15. The order-receiving-side negotiation device according to claim 2, wherein
the program including step of determining a negotiation candidate whose product of the utility value for the order-receiving side and the utility value for the order-placing source is the largest as the negotiation candidate with respect to the order proposal.

16. The order-receiving-side negotiation device according to claim 3, wherein
the program including step of determining a negotiation candidate whose product of the utility value for the order-receiving side and the utility value for the order-placing source is the largest as the negotiation candidate with respect to the order proposal.

17. The order-receiving-side negotiation device according to claim 14, wherein
the program including step of determining a negotiation candidate whose product of the utility value for the order-receiving side and the utility value for the order-placing source is the largest as the negotiation candidate with respect to the order proposal.

18. The order-receiving-side negotiation device according to claim 2, wherein
the program including step of determining a negotiation candidate that is most similar to the past negotiation candidate as the negotiation candidate with respect to the order proposal.

19. The order-receiving-side negotiation device according to claim 3, wherein
the program including step of determining a negotiation candidate that is most similar to the past negotiation candidate as the negotiation candidate with respect to the order proposal.

20. The order-receiving-side negotiation device according to claim 14, wherein
the program including step of determining a negotiation candidate that is most similar to the past negotiation candidate as the negotiation candidate with respect to the order proposal.
